(19) United States
(12) Patent Application Publication
(10) Pub. No.: US 2019/0339670 A1
(43) Pub. Date: Nov. 7, 2019

(54) SYSTEM AND METHOD FOR LATTICE STRUCTURE DESIGN FOR ADDITIVE MANUFACTURING

(71) Applicant: Siemens Product Lifecycle Management Software Inc., Plano, TX (US)

(72) Inventors: Tsz Ling Elaine Tang, Plainsboro, NJ (US); Da Lu, Plainsboro, NJ (US); Yan Liu, Plainsboro, NJ (US); Suraj Ravi Musuvathy, Princeton, NJ (US); Erhan Arisoy, Princeton, NJ (US); David Madeley, Louth (GB); Ashley Eckhoff, O'Fallon, MO (US)

(21) Appl. No.: 16/468,966

(22) PCT Filed: May 5, 2017
(86) PCT No.: PCT/US2017/031188

§ 371 Date: Jun. 12, 2019

Related U.S. Application Data
(60) Provisional application No. 62/457,461, filed on Feb. 10, 2017.

(51) Int. Cl. G05B 19/4099; G06F 17/50; B33Y 50/02; B29C 64/393

(52) U.S. Cl. CPC G05B 19/4099; G06F 17/5018; B33Y 50/02; G05B 2219/49007; G06F 2217/12; G06F 2217/16; G05B 2219/35134; B29C 64/393

(57) ABSTRACT

A system and method is provided for facilitate lattice structure design for additive manufacturing carried out through operation of at least one processor. The processor may be configured via executable instructions included in at least one memory to receive a three dimensional (3D) model of an object. The processor may also receive effective mechanical properties for at least a portion of the 3D model to be filled by a lattice producible by a 3D printer configured to produce the object. In addition the processor may determine lattice design parameters based on the received effective mechanical properties for the portion of the design. Or in the opposite direction, the processor may determine the effective mechanical properties based on the lattice design parameter. Further, the processor may modify the 3D model to include the lattice having the determined lattice design parameters for the portion of the 3D model.

### TECHNICAL FIELD

The present disclosure is directed, in general, to computer-aided design (CAD), computer-aided manufacturing (CAM), computer-aided engineering (CAE), visualization, simulation, and manufacturing systems, product data management (PDM) systems, product lifecycle management (PLM) systems, and similar systems, that are used to create, use, and manage data for products and other items (collectively referred to herein as product systems).

### BACKGROUND

Product systems may be used to create, use, and manage data involved with additive manufacturing of products. Such systems may benefit from improvements.

### SUMMARY

Variously disclosed embodiments include data processing systems and methods that may be used to facilitate a lattice structure design for additive manufacturing. In one example, a system may comprise at least one processor configured via executable instructions included in at least one memory to receive a three dimensional (3D) model of an object. The at least one processor may also be configured to receive effective mechanical properties for at least a portion of the 3D model to be filled by a lattice producible by a 3D printer configured to produce the object. Also, the at least one processor may be configured to determine lattice design parameters based on the received effective mechanical properties for the portion of the design. Further, the at least one processor may be configured to modify the 3D model to include the lattice having the determined lattice design parameters for the portion of the 3D model.

This example may carry out further or alternative functions as well. For example, the at least one processor may be configured to receive lattice design parameters for the portion of the 3D model; determine effective mechanical properties based on the received lattice design parameters; and display through at least one display the determined effective mechanical properties.

Other further or alternative functions may include the at least one processor: carrying out finite element analysis (FEA) to determine FEA data (138) that characterizes effective mechanical properties for lattice design parameters provided by a user; and storing the FEA data for the lattice design parameters in a data store. The functions of determining the lattice design parameters and/or the effective mechanical properties may then be based on the stored FEA data.

In another example, a method for lattice structure design for additive manufacturing may comprise acts carried out through operation of at least one processor that correspond to the functions for which the previously described at least one processor is configured to carry out.

A further example may include a non-transitory computer readable medium encoded with executable instructions (such as a software component on a storage device) that when executed, causes at least one processor to carry out this described method.

Another example may include a product or apparatus including at least one hardware, software, and/or firmware based processor, computer, component, controller, means, module, and/or unit configured for carrying out functionality corresponding to this described method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates a lattice structure design for additive manufacturing.

FIG. 2 schematically illustrates a solid cube to be replaced by lattice structures.

FIG. 3 schematically illustrates the design parameters of an f2ccz lattice.

FIG. 4 illustrates uniaxial test and shearing test results between (a) lattices and (b) fully filled solid prescribed with the effective mechanical properties of the lattices, where Z denotes the vertical direction.

FIG. 5 illustrates geometric models of examples of three f2ccz lattices with 3 unit cells in each direction.

FIG. 6 illustrates (a) a CAD model with a hollow space that is filled with (b) a lattice and (c) corresponding finite element mesh with a lattice replaced by a fully filled solid prescribed with the effective mechanical properties of the lattice.

FIG. 7 illustrates an example workflow.

FIG. 8 illustrates a flow diagram of an example methodology that facilitates a lattice structure design for additive manufacturing.

FIG. 9 illustrates a block diagram of a data processing system in which an embodiment may be implemented.

### DETAILED DESCRIPTION

Various technologies that pertain to systems and methods that facilitate a lattice structure design for additive manufacturing will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

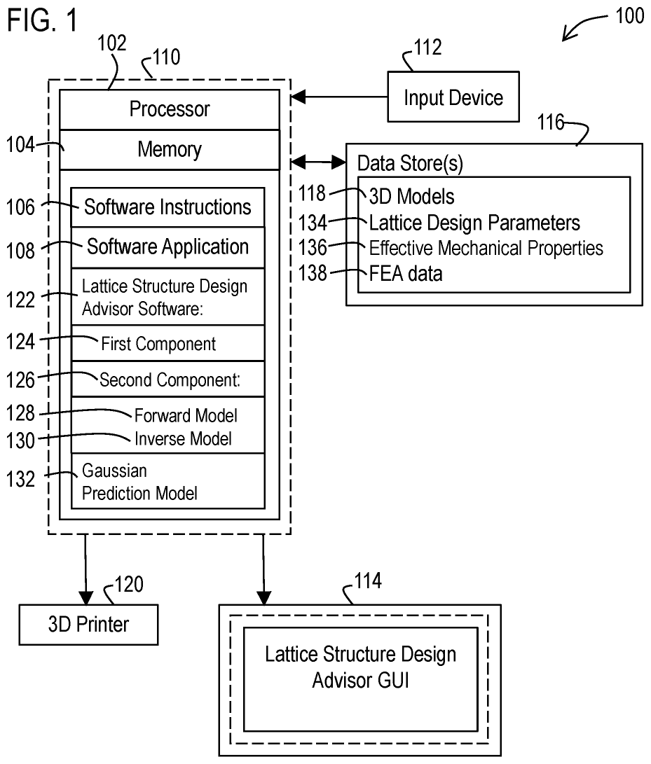

With reference to FIG. 1, an example data processing system 100 is illustrated that facilitates carrying out one or more of the embodiments described herein. The system 100 may include a combination 110 of at least one processor 102 (e.g., a microprocessor/CPU) that is configured to carry out various processes and functions described herein by executing from a memory 104, executable instructions 106 (such as software instructions) corresponding to one or more software applications 108 or portions thereof that are programmed to cause the at least one processor to carry out the various processes and functions described herein.

Such a memory 104 may correspond to an internal or external volatile memory (e.g., main memory, CPU cache, and/or RANI), that is included in the processor and/or in operative connection with the processor. Such a memory 104 may also correspond to a nonvolatile memory (e.g., flash memory, SSD, hard drive, or other storage device or non-transitory computer readable media) in operative connection with the processor.

The described data processing system 100 may include at least one input device 112 and at least one display device 114 in operative connection with the processor. The input device, for example, may include a mouse, keyboard, touch screen, or other type of input device capable of providing user inputs to the processor. The display device, for example, may include an LCD or AMOLED display screen, monitor, or any other type of display device capable of displaying outputs from the processor. For example, the processor 102, memory 104, software instructions 106, input device 112, and display device 114, may be included as part of a data processing system corresponding to a PC, workstation, server, notebook computer, tablet, mobile phone, or any other type of computing system, or any combination thereof.

The data processing system 100 may also include one or more data stores 116. The processor 102 may be configured to manage, retrieve, generate, use, revise, and store data and/or other information described herein from/in the data store 116. Examples of a data store may include a database (e.g., Oracle, Microsoft SQL Server), file system, hard drive, SSD, memory card and/or any other type of device or system that stores non-volatile data.

In example embodiments, the software application 108 may include one or more PLM software applications that may be adapted to carry out one or more of the processes and functions described herein. PLM software may include computer-aided design (CAD), computer-aided manufacturing (CAM), and computer-aided engineering (CAE) software. Examples of such PLM software applications may include the NX suite of applications, Solid Edge software, and/or Teamcenter software, produced by Siemens Product Lifecycle Management Software Inc., of Plano, Tex., US. However, it should be appreciated that the processes and functions described herein may be carried out using other product systems that manage, retrieve, generate, use, revise, and/or store product data.

In example embodiments, the software application 108 may be configured to work with, three dimensional (3D) models 118. Such 3D models may include solid/surface models of objects corresponding to data that specifies mathematical representations of a 3D volume/surface of the objects. Such 3D model data may be drawn by a user using CAD software and/or may be accessed from the data store 116 and/or from files (e.g., in a CAD format such as JT or STEP, or other format for storing geometric curves that define the shape of the part). In addition, it should also be appreciated that the 3D model data may be generated from a 3D scan of an existing physical part.

In some example embodiments, the system 100 may also be configured to generate instructions (such as G code) that is usable to direct a 3D printer 120 to carry out an additive manufacturing process to build a physical object having a shape corresponding to a 3D model.

Additive manufacturing allows designers to create physical freeform designs to achieve their desired design objectives and functionalities. Such designs may be printed with generally fully filled solid materials. However, in another approach, 3D printed lattices may be printed by the 3D printer for portions of the object in place of fully filled solid materials. Lattice structures are interconnected patterns of 3D geometric shapes (e.g., lattice struts). And thus (depending on their design) may achieve similar structural properties as a fully filled solid material, with the added benefit of using less material and having less weight.

However, it should be appreciated that the simulation and evaluation of mechanical properties of lattice structures may be more computationally difficult than the simulation and evaluation of mechanical properties of solid materials. In order to improve the ability of a user to select an appropriate lattice for a design to be generated via a 3D printer, an example embodiment employs a homogenization approach that involves the analysis of the macrostructure performance of lattices (e.g., stiffness of the matrix as a whole), which may be computationally more efficient and/or relevant to an overall analysis of the design than an approach that involves structural behaviors of interior struts of the lattice.

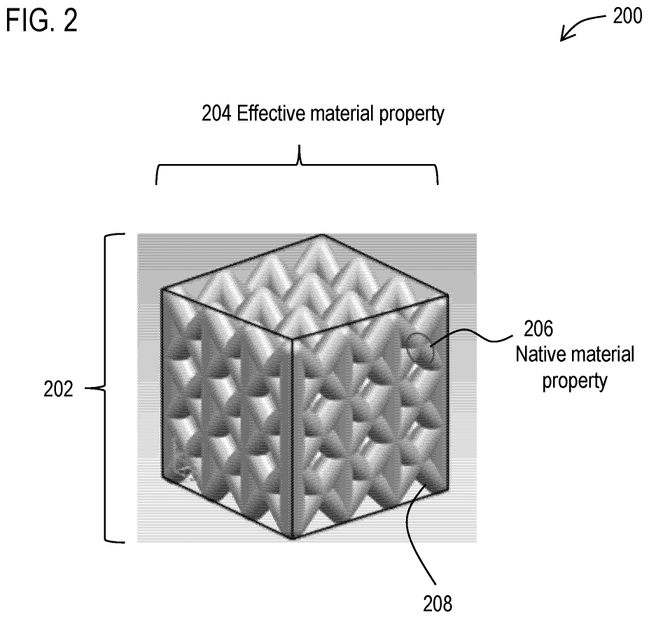

For example, as schematically illustrated in FIG. 2, the resulting lattice 200 as a whole 202 (based on the placement of the lattice struts 208) may have different effective mechanical properties 204 than the native material properties 206 that comprise the struts. As used herein, such effective mechanical properties correspond to homogenized material properties such as one or more of Young's moduli, Poisson's ratio, shear moduli, and/or bulk moduli, for the overall portion of the design replaced with the lattice.

By strategically designing the shape and dimension of the lattices, such designed lattice structures can offer exceptional effective mechanical properties, while being light weight at the same time. Based on the geometric design and choice of material, lattice structures may also have relatively varying effective mechanical properties compared to a design that uses fully-filled solid material.

However, deriving the effective mechanical properties is often not intuitive. The effective properties of the lattice may need to be characterized during the design stage. This can be achieved by performing uniaxial and shearing tests on the actual 3D-printed object. In order to find the lattice design parameters that provide the desired mechanical properties, multiple design parameters may need to be evaluated. This requires significant time and resources to print the parts and perform the analysis. Finite element analysis (FEA) can offer significant savings on the material cost and print time. However, FEA still requires expertise and effort to generate the lattice models and perform the computational analysis. If the goal is to perform lattice design optimization, it means that the analysis will be repeated over multiple design iterations, which will require significant computational time, even when the analysis is automated.

The inference of lattice design parameters associated with certain structural performance may involve an optimization process, meaning for every candidate design the aforementioned FEA procedure may be carried out to evaluate structural performance. The example embodiments described herein in more detail below, are able to improve efficiency of the design parameter inference process by enabling both forward and inverse modeling.

Referring back to FIG. 1, a forward model 128 may be used by the system 100 to quickly predict lattice structural performance (e.g., effective mechanical properties 136) based on specified lattice design parameters 134 provided by the user. An inverse model 130 may be used by the system 100 to carry out the prediction in the reverse direction (e.g., determining lattice design parameters 134 based on specified effective mechanical properties 136).

These models provide a quick design suggestion of lattice parameters/structural performance to users in the early conceptual design stage. Thus, if designers want to incorporate a lattice structure in a component, they can use the software application 108 described herein to optimize the settings automatically for a particular target area in a 3D model of the component. The software, for example, may be configured to calculate a lattice structure that will maintain the stability of the component while weighing a lot less, depending on requirements specified by the user.

As illustrated in FIG. 1, the described software application 108 may include a lattice structure design advisor software 122 that is configured to aid the designer in selecting lattice design parameters based on the desired mechanical properties for a specific lattice type in real-time. This software may include two major components 124, 126. The first component 124 may be configured to obtain lattice design data (effective lattice mechanical properties and for corresponding lattice design parameters) using FEA experiments to determine FEA data 138 that characterizes the macroscopic lattice structural properties for the lattice design data. The data provided by the first component may be computed offline (e.g., at a prior time) and stored in a data store for later use with the second component. In example embodiments, the FEA data provided by the first component for a wide range of different lattice designs, may be supplied with the lattice structure design advisor software 122 in order to expedite use of the second component.

The second component may be configured to carry out forward and inverse modeling using the FEA data obtained from the FEA experiments. For example, the second component may include the forward model 128 that is used to receive user-defined lattice design parameters as an input and compute the effective mechanical properties as an output. Also for example, the second component may include the inverse model 130 to receive user-defined effective mechanical properties as an input and compute the design parameters as an output.

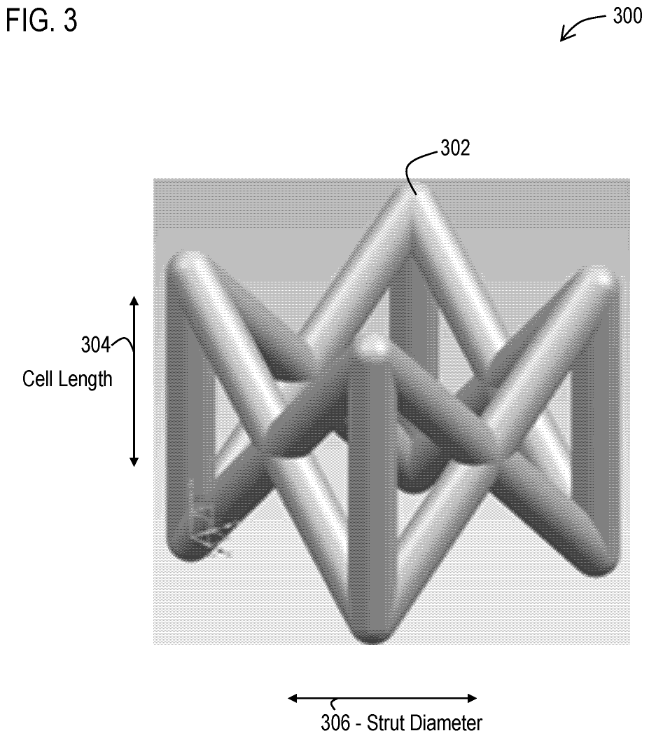

FIG. 3 illustrates as schematic illustration 300 of lattice design parameters that may be investigated using the previously described first component 124. Such design parameters may include unit cell length 304, strut diameter 306, lattice design shape 302 (such as the depicted f2ccz lattice or any other lattice shape), any other parameters that define the design of the lattice, and/or any combinations thereof.

In this example, the first component may be configured to determine macroscopic/homogenization effective mechanical properties for a plurality of different combinations of design parameters. Such effective mechanical properties may include Young's moduli, Poisson's ratio, shear moduli, and/or bulk moduli in one or more principal directions for the homogenization, and/or any other mechanical properties for the lattices defined by the different combinations of lattice parameters.

For example, the first component may be used to analyze lattice structures with 3×3×3 unit cells. Effective mechanical properties of the macroscopic lattice structure may be determined by assuming the lattice as a fully filled uniform continuum. The macroscopic constitutive equation may then be expressed in terms of the desired Young's moduli, Poisson's ratio and shear moduli. For example, the macroscopic structural stress-strain relationship may be expressed in Eq. (1).

$$( \begin{matrix}{ɛ}_{xx} \\ {ɛ}_{yy} \\ {ɛ}_{zz} \\ 2 {ɛ}_{yz} \\ 2 {ɛ}_{zx} \\ 2 {ɛ}_{xy}\end{matrix} ) = ( \begin{matrix}1 / {E}_{x} & - {v}_{yx} / {E}_{y} & - {v}_{zx} / {E}_{z} & 0 & 0 & 0 \\ - {v}_{xy} / {E}_{x} & 1 / {E}_{y} & - {v}_{zy} / {E}_{z} & 0 & 0 & 0 \\ - {v}_{xz} / {E}_{z} & - {v}_{yz} / {E}_{y} & 1 / {E}_{z} & 0 & 0 & 0 \\ 0 & 0 & 0 & 1 / {G}_{yz} & 0 & 0 \\ 0 & 0 & 0 & 0 & 1 / {G}_{zx} & 0 \\ 0 & 0 & 0 & 0 & 0 & 1 / {G}_{xy}\end{matrix} ) ( \begin{matrix}{σ}_{xx} \\ {σ}_{yy} \\ {σ}_{zz} \\ {σ}_{yz} \\ {σ}_{zx} \\ {σ}_{xy}\end{matrix} ) \qquad ( 1 )$$

where:
Eᵢ=Young's modulus along direction i
Eᵢⱼ=Component of strain tensor
Gᵢⱼ=Shear modulus in direction j on the plane with normal in direction i
σᵢⱼ=Component of stress tensor
νᵢⱼ=Poisson's ratio that corresponds to a contraction in direction j when an extension is applied in direction i.

Uniaxial tension and shearing tests can be performed to calculate the effective mechanical properties of the lattice design. Note that the approach is illustrated with f2ccz lattice, which has orthotopic material properties, but the approach may be applied to different lattice shapes with any isotropic/anisotropic material properties. Such simulations may be carried out by simulation features included in the first component and/or accessed from the PLM software application 108 that includes the first component. For example, NX Nastran of the previously described Siemens NX suite of applications may be accessed by the first component to perform linear statics analysis (SOL 101). The lattice structures can be represented as finite element model for analysis, for example, with NX Nastran.

For example, for the uniaxial tension test in Z direction, the degree of freedom (DOF) 3, 4, 5 may be fixed for nodes at the bottom plane (Z=0). Also, a strain rate may be applied on the Z direction. The deformation in X and Y directions due to the Z direction strain can be measured, with the strain calculated as:

$${ɛ}_{xx} = \frac{Displacement in X}{Length of X Edge} , {ɛ}_{yy} = {ɛ}_{xx} \qquad ( 2 )$$

Stress on the Z direction σ_{zz} may be computed with the following equation, based on the FEA results:

$${σ}_{zz} = \frac{Reaction Force in Z}{Area of XY Face} \qquad ( 3 )$$

With these determined strain and stress values, the first component 124 can apply the Eq. (1) to determine the values of E_{z} and ν_{zy} of the lattice. Similar, uniaxial tension test can be performed for other directions as well.

The shearing test in YZ plane may also be performed with FEA simulations by the first component to measure shear moduli of the lattice structure. A shear strain (ε_{yz}+ε_{zy}) may be imposed on the YZ plane by enforcing the displacement of DOF2. Shear stress σ_{zy} may then be computed by collecting the reaction forces at Y direction using the following equation:

$${σ}_{zy} = \frac{Reaction Force in Y}{Area of XY Face} \qquad ( 4 )$$

By applying a similar procedure for different directions, the shear stress and shear strain within the constitutive equation can be obtained, the shear moduli may be computed.

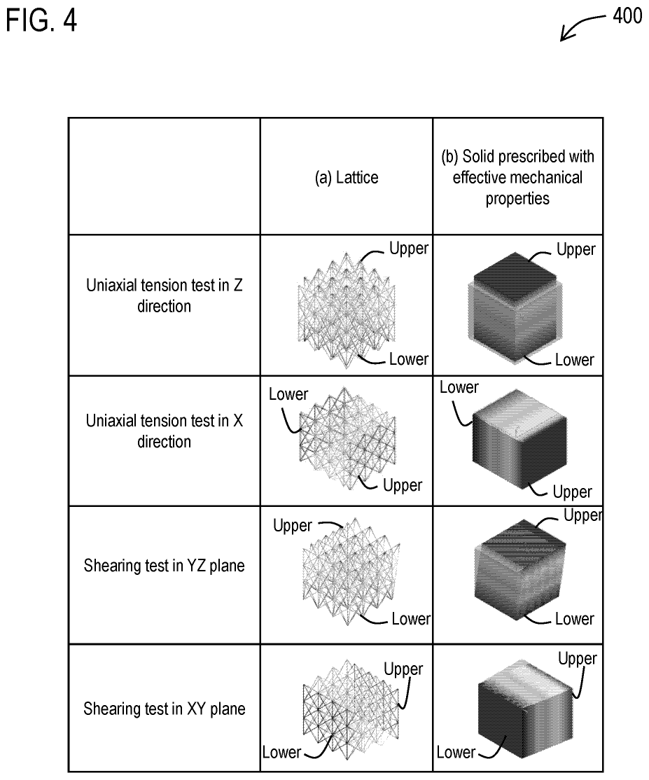

FIG. 4 shows a table 400 that illustrates the application of the previously described uniaxial and shearing tests to an f2ccz lattice compared to a corresponding completely filled uniform solid cube of the same volume as an illustration.

Visual outputs provided through the display device by the described software application 108 may include colored versions of FIG. 4, in which different colors on the lattice or solid cube (such as red and blue) represent different levels of the property being depicted (such as displacement caused by the test relative to the original shape of the object). For example, a color red (dark gray/black in FIG. 4) may illustrate the relatively upper most level (e.g., for portions of the lattice or solid cube with the highest displacement. Whereas blue (also dark gray/black in FIG. 4) may represent the relatively lowest level (e.g., for portions of the lattice or solid cube with the lowest displacement), with other colors such as green and yellow (lighter shades of gray) depicting levels therebetween. Because FIG. 4 (and other Figures herein) is depicted in grayscale, corresponding shades that depict the “upper” and “lower” levels are labeled to facilitate understanding of the graphs in the Figures. Lighter Gray levels in between these upper and lower ranges represented in darker shades are to be understood as representing intermediate levels.

In order to explore lattice structural performance over a range of design parameters, design of experiment (DOE) may be implemented by the first component. The purpose of DOE is to guide the choice of FEA experiments to generate the necessary data for the forward and inverse model. In this described example, various sizes of the f2ccz type lattice design shape may be simulated with the described FEA experiments. The lattice cell length and strut diameter may be defined as two design factors that have considerable impact on macroscopic structural design performance. However, it should be appreciated that in alternative embodiments, other factors and numbers of factors may be used.

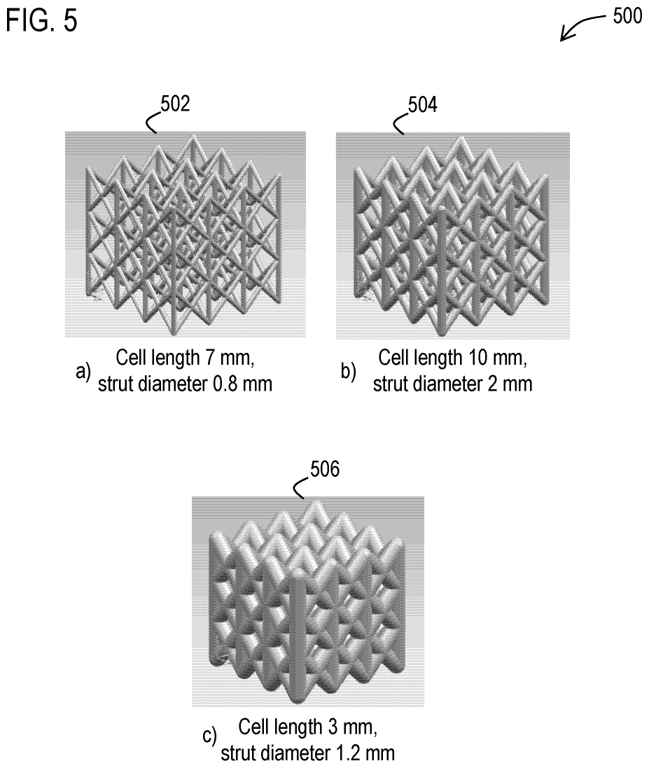

A full factorial design method may be used by the first component to determine FEA data for the f2ccz type lattice structure with the various local lattice shapes defined by these factors. Such a full factorial design method may avoid confounding the effects of the parameters. Thus, the samples used may correspond to different combinations of the factors values. In this example, there may be 39 sample designs in total: 48 excluding 9 geometrically unreasonable combinations (strut diameter being larger than cell length). Three examples 500 of the 39 examples of sampled lattice designs are visualized in Error! Reference source not found.5. In FIG. 5, lattice (a) 502 corresponds to a sample with a cell length of 7 mm and a strut diameter of 0.8 mm. Lattice (b) 504 corresponds to a sample with a cell length of 10 mm and a strut diameter of 2 mm. Lattice (c) 506 corresponds to a cell length of 3 mm and a strut diameter of 1.2 mm. It should be appreciated, that implementations of the embodiments described herein may include additional and/or alternative design samples for use by the first component to determine FEA data.

Referring back to FIG. 1, in an example embodiment, the forward model 128 of the second component 126 may carry out forward modeling using lattice design parameters 134 (e.g., cell length, strut diameter) provided by the user to determine effective mechanical properties (e.g., Young's moduli, Poisson's ratio, shear moduli, bulk moduli) based on characterization data that approximates the previously described FEA experimental simulation results provided by the first component. Such lattice design parameters 134 may be received through the input device 112 and/or may be received from the data store 116. The determined effective mechanical properties 136 may be displayed through the display device 114 and/or stored in the data store 116

Similarly, the inverse model 130 of the second component 126 may carry out inverse modeling to determine corresponding lattice design parameters 134 (e.g., cell length, strut diameter) based on desired effective lattice mechanical properties 136 (Young's moduli, Poisson's ratio, and shear moduli, bulk moduli) received from the user (via an input device and/or data store), without time-consuming optimization and simulations. Such determined lattice design parameters 134 may be displayed through the display device 114 and/or stored in the data store 116.

This described approach may better meet the time-to-solution pressure by utilizing and learning data (provided by the first component) to map sampled points in the design variable space to the objective space. In an example embodiment, the lattice structure guidance software may include a graphical user interface including menu items, buttons, tabs, windows, and other user interface objects that when executed prompt a user for any needed inputs (e.g., either lattice design parameters or mechanical properties) and display the corresponding determined information (e.g., either effective mechanical properties or lattice design parameters.)

In an example embodiment, modeling of lattice data produced by the first component may be implemented using a Gaussian predication model 132 by the second component. Such a Gaussian prediction model corresponds to a machine-learning algorithm, which uses kernel function to measure the similarity between data points. In a Gaussian prediction model, every point in the continuous design space is a normal distributed random variable. Collection of these random variables has a multivariate normal distribution. Such a Gaussian prediction model may be used to predict the response value at an unobserved point based on a set of sample points through a realization of a regression and stochastic process:

ŷ(x)=ƒ^{T}β+z(x) (5)

where ƒ are regression basis functions by user's choice and β are regression coefficients. The stochastic process z is assumed to have zero mean and a covariance of:

E_{c}[z(xᵢ)z(xⱼ)]=σ_{ν}²R(θ,xᵢ,xⱼ) (6)

where σ_{ν} is the process variance and R(θ, xᵢ, xⱼ) is the correlation model. A Gaussian correlation model follows:

R(θ,xᵢ,xⱼ)=exp(−Σₖ₌₁ⁿ^{_{ν}}θₖ(|xₖⁱ−xₖ^{j}|²)) (7)

where θ is correlation parameter vector that is found by optimizing a maximum likelihood function. After solving for correlation parameter the Gaussian process predicts an unobserved point with the following function:

ŷ(x)=ƒ^{T}β+r^{T}(x)R⁻¹(Y−Fβ) (8)

where β is computed by least square regression, the vector r measures the correlation between unobserved point and sampled points [x₁ . . . xₘ].

In the following example, the principle direction Young's moduli and Poisson's ratio are adopted here as the structural performance (i.e., effective mechanical properties) metrics, and lattice geometric ratio (strut diameter to cell length ratio) is used as the metric to represent the lattice design parameters input. Here, the Gaussian prediction model is first implemented in the forward modeling to estimate the homogenized structural properties. Lattice design parameter input is generalized with a non-parametric geometric ratio:

$$X = \frac{Strut diameter}{Cell length} \qquad ( 9 )$$

Elastic modulus and Poisson's ratio in the principle directions are the structural response to be estimated:

Y=[E_{z},ν_{zx}] (10)

Similar definitions may then be applied for the inverse model, where the desired structural properties (effective mechanical properties) are the input and the geometric ratio (lattice design parameters) is the output.

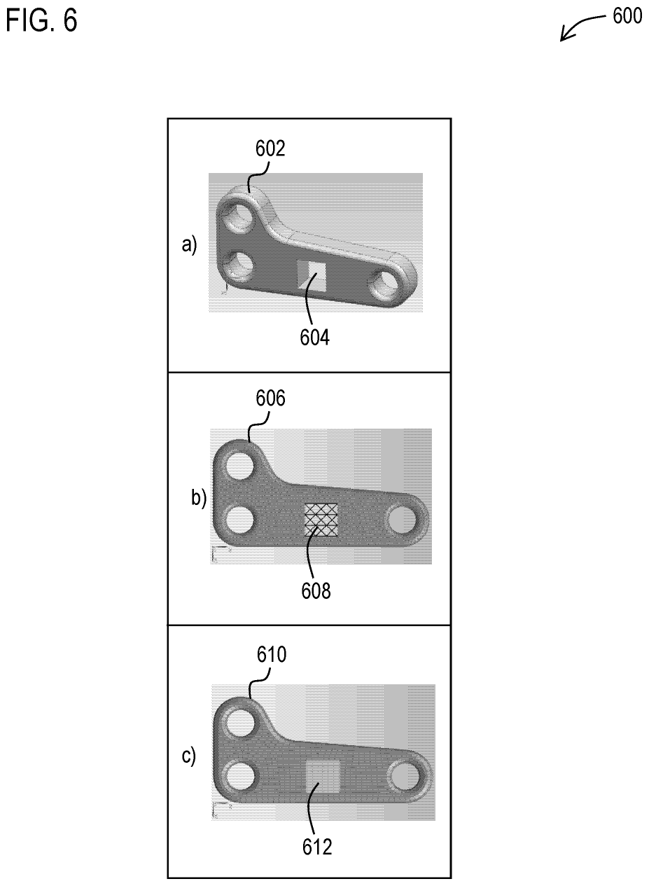

FIG. 6. illustrates an example 600 implementation of a lattice structure design advisor and a validation of the resulting design. In this example, the processor may be configured via the software application to receive a 3D model 602 of an object (e.g., responsive to one or more inputs through the input device). The processor may also be configured via the software application to receive effective mechanical properties for at least a portion 604 of the 3D model 602 to be filled by a lattice 608 producible by the 3D printer 120 configured to produce the object. In addition, the processor may be configured via the software application to determine lattice design parameters (i.e., the described inverse modeling) based on the received effective mechanical properties for the portion of the design. Further the processor may be configured via the software application to modify the 3D model to include the lattice having the determined lattice design parameters for the portion of the 3D model.

In this example, the previously described forward model may also be carried out by the software to help quickly estimate the structure performance (i.e., determine effective mechanical properties) of a user provided lattice 608 for the portion 604 of the design, based on received user-defined lattice design parameters. The processor may be configured by the software application to cause the determined effective mechanical properties to be outputted through the display device 114 and/or stored in a data store.

In this example, view (a) of FIG. 6 illustrates the 3D (e.g., CAD) model 602 with the portion (i.e., a hollow space) 604 to be filled with a lattice 608. View (b) illustrates a finite element mesh 606 with lattices 608 filling the follow space 604. View (c) illustrates a finite element mesh 610 with the lattice replaced by a fully filled solid 612 prescribed with effective mechanical property of the lattice.

The forward model based on the described Gaussian process provides a quick approximation of effective mechanical properties with lattice design parameter input. The described system and software enables a user to obtain initial design knowledge of the structural performance with certain lattice parameters. Also, using the inverse model, the user can derive the lattice design parameters for desired mechanical properties. This described lattice structure design guidance system may include linear static analysis of an orthotropic cubic lattice. However, it should be understood that further embodiments, may be extended to other lattice shapes (e.g., different types of lattice such as for example, tetrahedral, hexagons, cylinders of different diameters, thicknesses and orientations). In further alternative embodiments, non-linear structural behavior, as well as geometric deviations caused by the manufacturing process (e.g., layer deposition effects) may also be taken into account via the described system.

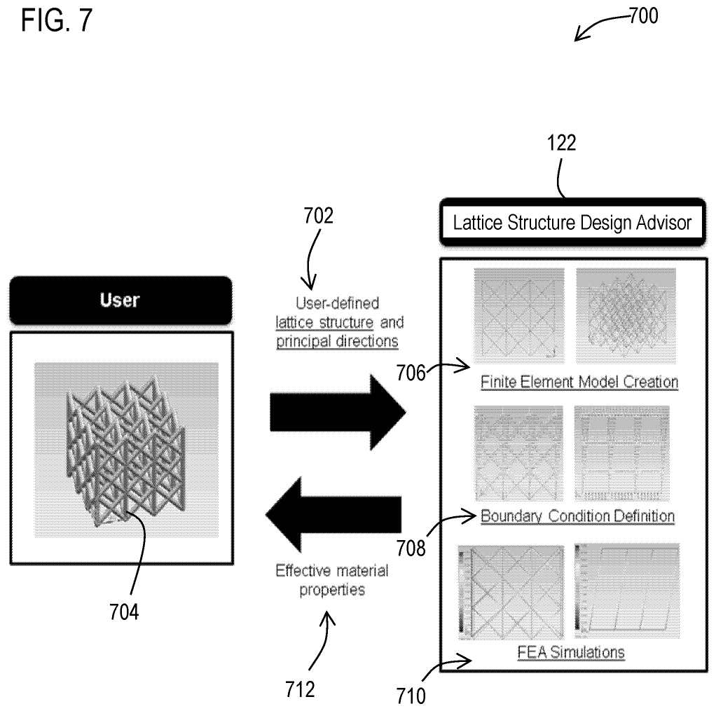

FIG. 7 illustrates an example workflow 700 that the previously described lattice structure design advisor software may be configured to carry out. In this workflow, a user may use the software tool to provide one or more inputs 702. Such inputs may correspond to the creation and/or selection of a 3D CAD model 704 for a desired lattice structure unit cell. Such inputs may also define the principal directions of the lattice structure. Based on these inputs, the described software 122 may then automatically create a finite element mesh 706, set up the boundary condition 708 accordingly, and perform the FEA simulations 710. Such simulations may determine FEA data that characterizes effective mechanical properties for the lattice design parameters provided by the user. The software may then provide outputs 712 (to a display and/or data store) corresponding to the determined effective mechanical properties for the lattice (e.g., Young's modulus, Poisson ratio and/or shear modulus).

Such a workflow provides a method for automatic homogenization of lattice effective material properties, in which the user inputs the lattice design, and the tool will automatically compute the effective mechanical properties with FEA. And as an additional feature, the tool may then collect these data generated by the user, and store in a central location (such as the previously described data store 116) for later use (e.g., be used as FEA data for the described inverse/forward models of the described second component).

The described software application may be configured to automate these described calculations using API's of a PLM software application, for example, to carry out the automatic characterization of lattice effective mechanical properties for the user's lattice design. For example, the advisor software tool may use Siemens NX Open, which is a collection of APIs that allows the creation of custom applications for Siemens PLM's NX software through an open architecture. This software tool may leverage Siemens NX's capability of finite element model creation, and NX Nastran FEA capabilities. However, it should be understood the described advisor software tool may be adapted to work with other PLM software and/or APIs to carry out the features described herein.

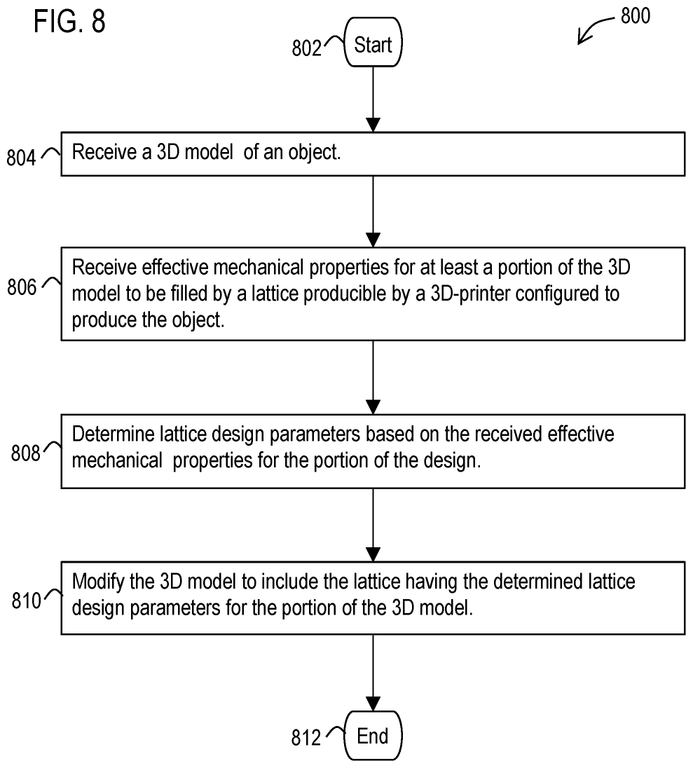

Referring now to FIG. 8, a methodology 800 is illustrated that facilitates a lattice structure design for additive manufacturing. While the methodology is described as being a series of acts that are performed in a sequence, it is to be understood that the methodology may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The methodology may start at 802 and may include several acts carried out through operation of at least one processor. These acts may include an act 804 of receiving a three dimensional (3D) model of an object. Also, the methodology may include an act 806 of receiving effective mechanical properties for at least a portion of the 3D model to be filled by a lattice producible by a 3D printer configured to produce the object. In addition, the methodology may include an act 808 of determining lattice design parameters based on the received effective mechanical properties for the portion of the design. Further, the methodology may include an act 810 of modifying the 3D model to include the lattice having the determined lattice design parameters for the portion of the 3D model. At 812 the methodology may end.

Also, it should be appreciated that this described methodology may include additional acts and/or alternative acts corresponding to the features described previously with respect to the data processing system 100.

For example, the methodology may include acts of; receiving lattice design parameters for the portion of the 3D model; determining effective mechanical properties based on the received lattice design parameters; and displaying through at least one display the determined effective mechanical properties.

In example embodiments, the lattice design parameters may include data corresponding to at least one of lattice cell size, lattice strut diameter, or any combination thereof. Further, the effective mechanical properties may include at least one of Young's moduli, Poisson's ratio, shear moduli, bulk moduli, or any combination thereof.

The methodology may also include: an act of carrying out finite element analysis (FEA) to determine FEA data that characterizes effective mechanical properties for lattice design parameters provided by a user; and an act of storing the FEA data for the lattice design parameters in a data store. The acts of determining the lattice design parameters and/or determining the effective mechanical properties may be further carried out based on the stored FEA data. Also, in this described example, the method may include at least one of determining lattice design parameters or determining effective mechanical properties based on a Gaussian prediction model and the FEA data.

In further example embodiments, the methodology may include causing a display device to output data indicative of the information generated by these described embodiments.

In addition, the example methodology may include generating instructions (e.g., G code) based on the modified model that are configured to direct a 3D printer to produce the object including the lattice. Further, the methodology may comprise through operation of the 3D printer, producing the object using the generated instructions.

As discussed previously, acts associated with the above-described methodologies (other than any described manual acts) may be carried out by one or more processors 102. Such processor(s) may be included in one or more data processing systems 100, for example, that execute from at least one memory 104 executable instructions 106 (such as software instructions) that are operative to cause these acts to be carried out by the one or more processors.

Also, as used herein a processor corresponds to any electronic device that is configured via hardware circuits, software, and/or firmware to process data. For example, processors described herein may correspond to one or more (or a combination) of a microprocessor, CPU, or any other integrated circuit (IC) or other type of circuit that is capable of processing data in a data processing system. It should be understood that a processor that is described or claimed as being configured to carry out a particular described/claimed process or function may: correspond to a CPU that executes computer/processor executable instructions stored in a memory in the form of software and/or firmware to carry out such a described/claimed process or function; and/or may correspond to an IC that is hard wired with processing circuitry (e.g., an FPGA or ASIC IC) to carry out such a described/claimed process or function.

It should also be understood that a processor that is described or claimed as being configured to carry out a particular described/claimed process or function may correspond to the combination 110 of the processor 102 with the software instructions 106 loaded/installed into the described memory 104 (volatile and/or non-volatile), which are currently being executed and/or are available to be executed by the processor to cause the processor to carry out the described/claimed process or function. Thus, a processor that is powered off or is executing other software, but has the described software instructions installed on a storage device in operative connection therewith (such as a hard drive or SSD) in a manner that is setup to be executed by the processor (when started by a user, hardware and/or other software), may also correspond to the described/claimed processor that is configured to carry out the particular processes and functions described/claimed herein.

Further the phrase “at least one” before an element (e.g., a processor) that is configured to carry out more than one function/process may correspond to one or more elements (e.g., processors) that each carry out the functions/processes and may also correspond to two or more of the elements (e.g., processors) that respectively carry out different ones of the one or more different functions/processes.

It is important to note that while the disclosure includes a description in the context of a fully functional system and/or a series of acts, those skilled in the art will appreciate that at least portions of the mechanism of the present disclosure and/or described acts are capable of being distributed in the form of computer/processor executable instructions (e.g., the described software instructions and/or corresponding firmware instructions) contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, hard disk drives, SSDs, flash memory, CDs, DVDs, and Blu-ray disks. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, C, C#, C++ or any other form of code that can be programmed/configured to cause at least one processor to carry out the acts and features described herein. Still further, results of the described/claimed processes or functions may be stored in a computer-readable medium, displayed on a display device, and/or the like.

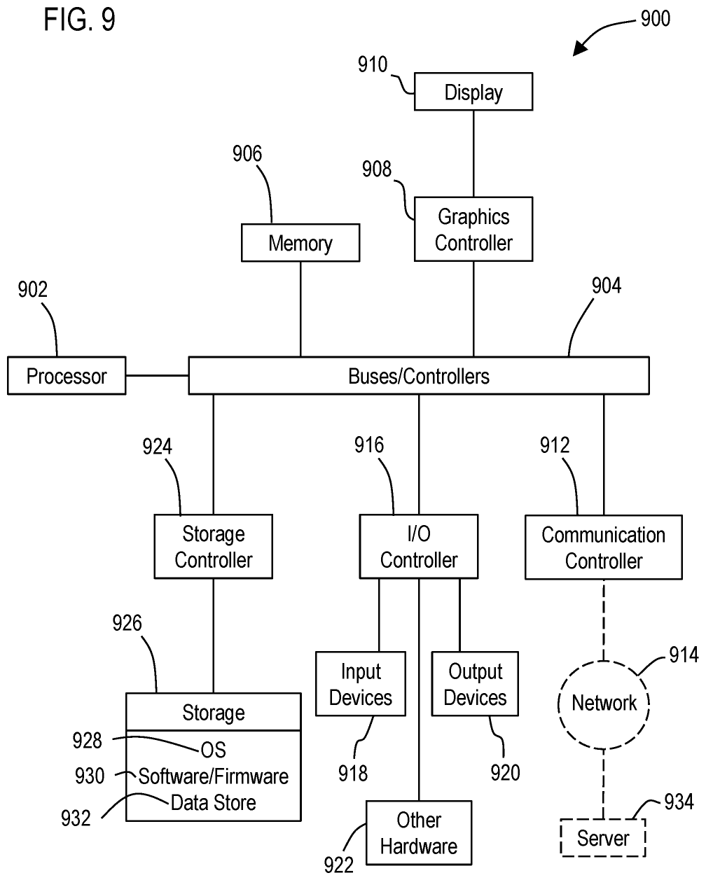

FIG. 9 illustrates a block diagram of a data processing system 900 (e.g., a computer system) in which an embodiment can be implemented, such as the previously described system 90, and/or other system operatively configured by computer/processor executable instructions, circuits, or otherwise to perform the functions and processes as described herein. The data processing system depicted includes at least one processor 902 (e.g., a CPU) that may be connected to one or more bridges/controllers/buses 904 (e.g., a north bridge, a south bridge). One of the buses 904, for example, may include one or more I/O buses such as a PCI Express bus. Also connected to various buses in the depicted example may include a main memory 906 (RANI) and a graphics controller 908. The graphics controller 908 may be connected to one or more display devices 910 (e.g., LCD or AMOLED display screen, monitor, VR headset, and/or projector). It should also be noted that the processor 902 may include a CPU cache memory. Further, in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 912 (Ethernet controllers, WiFi controllers, cellular controllers) operative to connect to a local area network (LAN), Wide Area Network (WAN), a cellular network, and/or other wired or wireless networks 914 or communication equipment.

Further components connected to various busses may include one or more I/O controllers 916 such as USB controllers, Bluetooth controllers, and/or dedicated audio controllers (connected to speakers and/or microphones). It should also be appreciated that various peripherals may be connected to the I/O controller(s) (via various ports and connections) including input devices 918 (e.g., keyboard, mouse, pointer, touch screen, touch pad, drawing tablet, trackball, buttons, keypad, game controller, gamepad, camera, microphone, scanners, motion sensing devices that capture motion gestures), output devices 920 (e.g., printers, speakers) or any other type of device that is operative to provide inputs to or receive outputs from the data processing system.

Also, it should be appreciated that many devices referred to as input devices or output devices may both provide inputs and receive outputs of communications with the data processing system. For example, the processor 902 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other peripheral hardware 922 connected to the I/O controllers 916 may include any type of device, machine, or component that is configured to communicate with a data processing system.

Additional components connected to various busses may include one or more storage controllers 924 (e.g., SATA). A storage controller may be connected to a storage device 926 such as one or more storage drives and/or any associated removable media, which can be any suitable non-transitory machine usable or machine readable storage medium. Examples, include nonvolatile devices, volatile devices, read only devices, writable devices, ROMs, EPROMs, magnetic tape storage, hard disk drives, solid-state drives (SSDs), flash memory, optical disk drives (CDs, DVDs, Blu-ray), and other known optical, electrical, or magnetic storage devices drives and/or computer media. Also in some examples, a storage device such as an SSD may be connected directly to an I/O bus 904 such as a PCI Express bus.

A data processing system in accordance with an embodiment of the present disclosure may include an operating system 928, software/firmware 930, and data stores 932 (that may be stored on a storage device 926 and/or the memory 906). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 912 may be connected to the network 914 (which may or may not be a part of a data processing system 900), which can be any local, wide area, remote, private, and/or public data processing system network or combination of networks, as known to those of skill in the art, including the Internet. Data processing system 900 can communicate over the network 914 with one or more other data processing systems such as a server 934 (which may in combination correspond to a larger data processing system). For example, a larger data processing system may correspond to a plurality of smaller data processing systems implemented as part of a distributed system in which processors associated with several smaller data processing systems may be in communication by way of one or more network connections and may collectively perform tasks described as being performed by a single larger data processing system. Thus, it is to be understood that when referring to a data processing system, such a system may be implemented across several data processing systems organized in a distributed system in communication with each other via a network.

It should also be understood that the term “controller” means any device, system or part thereof that controls at least one operation, whether such a device is implemented in hardware, firmware, software or any combination thereof. It should be noted that the functionality associated with any particular controller may be centralized or distributed, whether locally or remotely. The described processor and memory may be included in a controller. Further, a controller may correspond to the described data processing system or any other hardware circuit that is operative to control at least one operation.

In addition, it should be appreciated that data processing systems may include virtual machines in a virtual machine architecture or cloud environment. For example, the processor 902 and associated components may correspond to the combination of one or more virtual machine processors of a virtual machine operating in one or more physical processors of a physical data processing system. Examples of virtual machine architectures include VMware ESCi, Microsoft Hyper-V, Xen, and KVM.

Also, it should be noted that the processor described herein may correspond to a remote processor located in a data processing system such as a server that is remote from the display and input devices described herein. In such an example, the described display device and input device may be included in a client data processing system (which may have its own processor) that communicates with the server (which includes the remote processor) through a wired or wireless network (which may include the Internet). In some embodiments, such a client data processing system, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In another example, such a client data processing system may execute a web browser or thin client application. Inputs from the user may be transmitted from the web browser or thin client application to be evaluated on the server, rendered by the server, and an image (or series of images) sent back to the client data processing system to be displayed by the web browser or thin client application. Also in some examples, the remote processor described herein may correspond to a combination of a virtual processor of a virtual machine executing in a physical processor of the server.

Those of ordinary skill in the art will appreciate that the hardware depicted for the data processing system may vary for particular implementations. For example, the data processing system 900 in this example may correspond to a controller, computer, workstation, server, PC, notebook computer, tablet, mobile phone, and/or any other type of apparatus/system that is operative to process data and carry out functionality and features described herein associated with the operation of a data processing system, computer, processor, software components, and/or a controller discussed herein. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system 900 may conform to any of the various current implementations and practices known in the art.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form. In addition, this application claims priority to U.S. application No. 62/457,461 filed Feb. 10, 2017, which is hereby incorporated herein by reference in its entirety.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

1. A system for lattice structure design for additive manufacturing comprising:
at least one processor configured via executable instructions included in at least one memory to:
receive a three dimensional (3D) model of an object;
receive effective mechanical properties for at least a portion of the 3D model to be filled by a lattice producible by a 3D printer configured to produce the object;
determine lattice design parameters based on the received effective mechanical properties for the portion of the design; and
modify the 3D model to include the lattice having the determined lattice design parameters for the portion of the 3D model.

2. The system according to claim 1, wherein the at least one processor is configured to:
receive lattice design parameters for the portion of the 3D model;
determine effective mechanical properties based on the received lattice design parameters; and
display through at least one display the determined effective mechanical properties.

3. The system according to claim 1, wherein the lattice design parameters include data corresponding to at least one of lattice cell size, lattice cell shape, lattice strut diameter, or any combination thereof.

4. The system according to claim 1, wherein the effective mechanical properties include at least one of Young's moduli, Poisson's ratio, shear moduli, bulk moduli, or any combination thereof.

5. The system according to claim 2, wherein the at least one processor is configured to:
carry out finite element analysis (FEA) to determine FEA data that characterizes effective mechanical properties for lattice design parameters provided by a user; and
storing the FEA data for the lattice design parameters in a data store; and
wherein the at least one processor is configured to determine the lattice design parameters and/or the effective mechanical properties is-further based on the stored FEA data.

6. The system according to claim 5, wherein the at least one processor is configured to determine the lattice design parameters or the effective mechanical properties based on a Gaussian prediction model and the FEA data.

7. The system according to claim 1, wherein the at least one processor is configured to generate instructions based on the modified 3D model that are configured to direct the 3D printer to produce the object including the lattice.

8. A method for lattice structure design for additive manufacturing comprising:
through operation of at least one processor:
receiving a three dimensional (3D) model of an object;
receiving effective mechanical properties for at least a portion of the 3D model to be filled by a lattice producible by a 3D-printer configured to produce the object;
determining lattice design parameters based on the received effective mechanical properties for the portion of the design; and
modifying the 3D model to include the lattice having the determined lattice design parameters for the portion of the 3D model.

9. The method according to claim 8, further comprising through operation of the at least one processor:
receiving lattice design parameters for the portion of the 3D model;
determining effective mechanical properties based on the received lattice design parameters; and
displaying through at least one display the determined effective mechanical properties.

10. The method according to claim 8, wherein the lattice design parameters include data corresponding to at least one of lattice cell size, lattice cell shape, lattice strut diameter, or any combination thereof.

11. The method according to claim 8, wherein the effective mechanical properties include at least one of Young's moduli, Poisson's ratio, shear moduli, bulk modulus, or any combination thereof.

12. The method according to claim 9, further comprising through operation of the at least one processor:
carrying out finite element analysis (FEA) to determine FEA data that characterizes effective mechanical properties for lattice design parameters provided by a user; and
storing the FEA data for the lattice design parameters in a data store; and
wherein determining the lattice design parameters and/or determining the effective mechanical properties is further carried out based on the stored FEA data.

13. The method according to claim 12, wherein at least one of the determining lattice design parameters or determining effective mechanical properties is carried out based on a Gaussian prediction model and the FEA data.

14. The method according to claim 8, through operation of the at least one processor, generating instructions based on the modified 3D model that are configured to direct the 3D printer to produce the object including the lattice.

15. A non-transitory computer readable medium encoded with executable instructions that when executed, cause at least one processor to:
receive a three dimensional (3D) model of an object;
receive effective mechanical properties for at least a portion of the 3D model to be filled by a lattice producible by a 3D-printer configured to produce the object;
determine lattice design parameters based on the received effective mechanical properties for the portion of the design; and
modify the 3D model to include the lattice having the determined lattice design parameters for the portion of the 3D model.

16. The non-transitory computer readable medium of claim 15, wherein the executable instructions, when executed, further cause the at least one processor to:
receive lattice design parameters for the portion of the 3D model;
determine effective mechanical properties based on the received lattice design parameters; and
display through at least one display the determined effective mechanical properties.

17. The non-transitory computer readable medium of claim 15, wherein:
the lattice design parameters include data corresponding to at least one of lattice cell size, lattice cell shape, lattice strut diameter, or any combination thereof; and
the effective mechanical properties include at least one of Young's moduli, Poisson's ratio, shear moduli, bulk modulus, or any combination thereof.

18. The non-transitory computer readable medium of claim 15, wherein the executable instructions, when executed, further cause the at least one processor to:
carry out finite element analysis (FEA) to determine FEA data that characterizes effective mechanical properties for lattice design parameters provided by a user; and
store the FEA data for the lattice design parameters in a data store; and
wherein the instructions, when executed, cause the at least one processor to determine the lattice design parameters and/or determine the effective mechanical properties further based on the stored FEA data.

19. The non-transitory computer readable medium of claim 15, wherein the executable instructions, when executed, cause the at least one processor to determine the lattice design parameters or the effective mechanical properties based on a Gaussian prediction model and the FEA data.

20. The non-transitory computer readable medium of claim 15, wherein the executable instructions, when executed, cause the at least one processor to generate instructions based on the modified 3D model that are configured to direct the 3D printer to produce the object including the lattice.
